(19) United States
(12) Patent Application Publication
(10) Pub. No.: US 2022/0346461 A1
(43) Pub. Date: Nov. 3, 2022

(54) UNDERGARMENT SYSTEMS AND METHODS

(71) Applicant: Wade Wittrock, Colorado Springs, CO (US)

(72) Inventor: Wade Wittrock, Colorado Springs, CO (US)

(21) Appl. No.: 17/246,304

(22) Filed: Apr. 30, 2021

(51) Int. Cl. A41B 9/02; A41B 9/00

(52) U.S. Cl. CPC A41B 9/023; A41B 9/001; A41B 2500/00

(57) ABSTRACT

Undergarment systems and methods are provided. According to one or more embodiments of the present disclosure, an undergarment system is provided. The undergarment system may include a first undergarment and a second undergarment. The first undergarment may have a waist size and include a first front pouch having a first pouch size. The second undergarment may have the waist size and include a second front pouch having a second pouch size. The first pouch size of the first undergarment may be different than the second pouch size of the second undergarment.

### TECHNICAL FIELD

One or more embodiments relate generally to undergarments and, more particularly, to systems and methods for men's undergarments having a customized front pouch size.

### BACKGROUND

Conventional undergarments are provided in standard sizes designed to fit average anatomical dimensions per size. Some individuals may have anatomies not suited to the standard sizes, leading to discomfort and/or improper fit/support. Therefore, there is a need in the art for systems and methods that address the above deficiencies, other deficiencies known in the industry, or at least offers an alternative to current techniques.

### SUMMARY

Systems and methods are provided for an undergarment. According to one or more embodiments of the present disclosure, an undergarment system is provided. The undergarment system may include a first undergarment and a second undergarment. The first undergarment may have a waist size and include a first front pouch having a first pouch size. The second undergarment may have the waist size and include a second front pouch having a second pouch size. The first pouch size of the first undergarment may be different than the second pouch size of the second undergarment.

According to one or more embodiments of the present disclosure, an undergarment is provided. The undergarment may include a first fabric panel, a second fabric panel, a third fabric panel, and a fourth fabric panel. The first fabric panel may include an annular elastomeric waistband. The second fabric panel may be connected to the first fabric panel and define a first leg opening. The third fabric panel may be connected to the first fabric panel and define a second leg opening. The fourth fabric panel may be connected to the first fabric panel, the second fabric panel, and the third fabric panel. The fourth fabric panel may be selected to provide a front pouch size as desired by a buyer.

According to one or more embodiments of the present disclosure, a method is provided. The method may include receiving, from a buyer, a first input indicating a desired waist size. The method may include receiving, from the buyer, a second input indicating a desired pouch size. The method may include providing, to the buyer, an undergarment having the desired waist size and the desired pouch size.

Additional features are set forth in part in the description that follows and will become apparent to those skilled in the art upon examination of the specification and drawings or may be learned by the practice of the disclosed subject matter. A further understanding of the nature and advantages of the present disclosure may be realized by reference to the remaining portions of the specification and the drawings, which forms a part of this disclosure.

One of skill in the art will understand that each of the various aspects and features of the disclosure may advantageously be used separately in some instances, or in combination with other aspects and features of the disclosure in other instances. Accordingly, individual aspects can be claimed separately or in combination with other aspects and features. Thus, the present disclosure is merely exemplary in nature and is in no way intended to limit the claimed invention or its applications or uses. It is to be understood that structural and/or logical changes may be made without departing from the spirit and scope of the present disclosure.

The present disclosure is set forth in various levels of detail and no limitation as to the scope of the claimed subject matter is intended by either the inclusion or non-inclusion of elements, components, or the like in this summary. In certain instances, details that are not necessary for an understanding of the disclosure or that render other details difficult to perceive may have been omitted. Moreover, for the purposes of clarity, detailed descriptions of certain features will not be discussed when they would be apparent to those with skill in the art so as not to obscure the description of the present disclosure. The claimed subject matter is not necessarily limited to the arrangements illustrated herein, with the scope of the present disclosure is defined only by the appended claims.

### BRIEF DESCRIPTION OF THE DRAWINGS

The description will be more fully understood with reference to the following figures in which components may not be drawn to scale, which are presented as various embodiments of the undergarment described herein and should not be construed as a complete depiction of the scope of the exercise system.

FIG. 1 illustrates a front perspective view of an undergarment, in accordance with an embodiment of the disclosure.

FIG. 2 illustrates a rear perspective view of the undergarment, in accordance with an embodiment of the disclosure.

FIG. 3 illustrates a front view of the undergarment, in accordance with an embodiment of the disclosure.

FIG. 4 illustrates a flow diagram of a method of customizing an undergarment, in accordance with an embodiment of the disclosure.

Embodiments of the disclosure and their advantages are best understood by referring to the detailed description that follows. It should be appreciated that like reference numerals may be used to identify like elements illustrated in one or more of the figures.

### DETAILED DESCRIPTION

According to the present disclosure, undergarment systems and methods are provided. An undergarment or undergarment system may be customizable to provide a desired front pouch size, such as to size the undergarment to the particular crotch anatomy of the buyer/user. The undergarment may be provided as part of an undergarment system. For example, an undergarment system may include a first undergarment and a second undergarment. The first undergarment may have a waist size and include a first front pouch having a first pouch size. The second undergarment may have the waist size and include a second front pouch having a second pouch size. To suit various anatomies, the first pouch size of the first undergarment may be different than the second pouch size of the second undergarment.

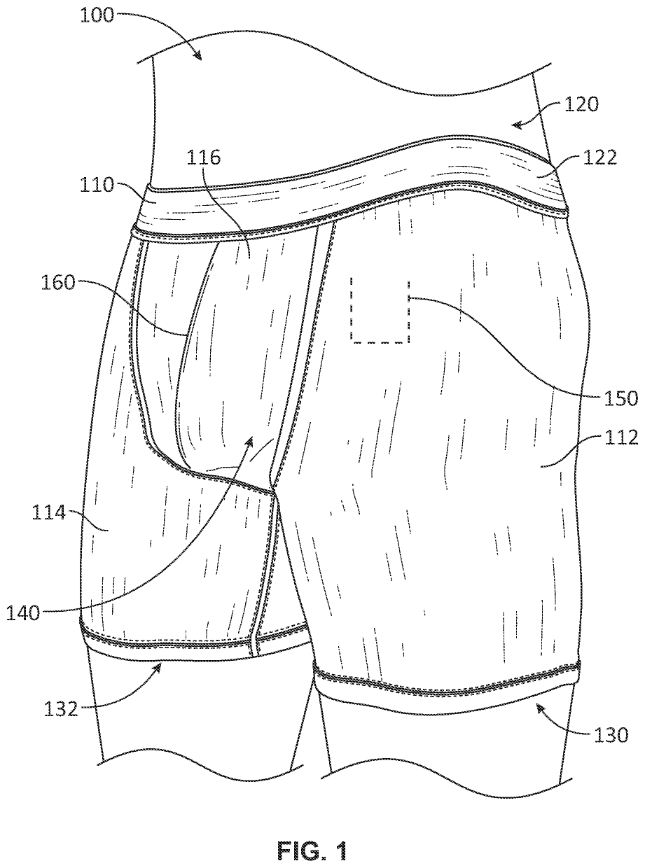

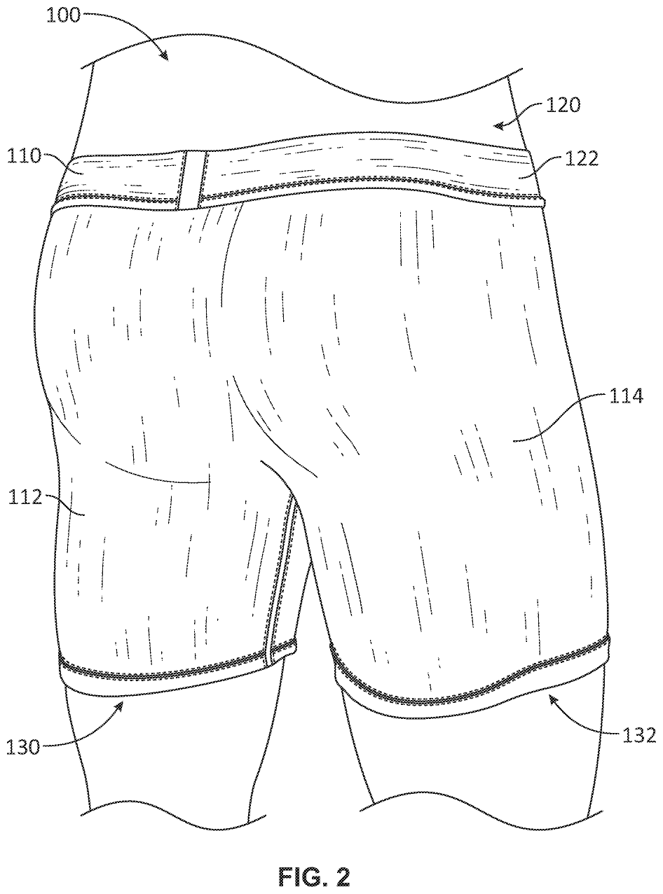

FIG. 1 illustrates a front perspective view of an undergarment 100, in accordance with an embodiment of the disclosure. FIG. 2 illustrates a rear perspective view of the undergarment 100, in accordance with an embodiment of the disclosure. Referring to FIGS. 1-2, the undergarment 100 may be an item of clothing configured to be worn beneath outer clothing, such as in direct contact with the skin. The undergarment 100 may provide many features and may be referred to as an underwear garment or underwear. For example, the undergarment 100 may serve to keep outer garments from being soiled or damaged by bodily excretions, to lessen the friction of outerwear against the skin, to shape the body, and to provide concealment or support for parts of the body. In embodiments, the undergarment 100 may be one of briefs, boxer briefs, or trunks, although other configurations are contemplated, as described below.

Although described as underwear, the term “undergarment” is used for convenience only, and the undergarment 100 may be any item of clothing configured to be worn on at least a portion of the lower extremities of a person. In addition, the undergarment 100 may be appropriate both as an undergarment and as outer clothing. For example, the concepts described herein with reference to underwear may be applied to shorts, pants, leggings, sweatpants, joggers, legwear, swimsuits, or swim shorts, among others. Thus, undergarment 100 may be any article of clothing, depending on the application.

As shown, the undergarment 100 may be a multi-panel garment. For example, the undergarment 100 may include a first fabric panel 110, a second fabric panel 112, a third fabric panel 114, and a fourth fabric panel 116, although other configurations are contemplated. For example, the undergarment 100 may include more than four panels, such as a fifth fabric panel, or the undergarment 100 may include less than four panels. The fabric panels may be formed from any suitable textile fabric. The fabric panels may be formed from the same material or from different material. For example, some fabric panels may include greater elasticity, differing weight, differing drape, or differing breathability compared to other panels of the undergarment 100 to provide a desired functional characteristic or feel.

The first fabric panel 110 may define a trunk opening or waist size 120. Depending on the application, the first fabric panel 110 may include or otherwise define an annular elastomeric waistband 122 or other confining fabric configured to encircle the waist and hold the undergarment 100 in place. The second fabric panel 112 may be connected to the first fabric panel 110 and define a first leg opening 130 (e.g., for the left leg of the wearer). Similarly, the third fabric panel 114 may be connected to the first fabric panel 110 and define a second leg opening 132 (e.g., for the right leg of the wearer). The second fabric panel 112 and third fabric panel 114 may be sewn, welded, or otherwise secured to the first fabric panel 110, such as along the bottom of the waistband 122.

As illustrated in FIG. 2, the second fabric panel 112 may be connected to the third fabric panel 114, such as along a seam along a vertical midline and at the rear of the undergarment 100. To define the first leg opening 130, the second fabric panel 112 may be wrapped and connected to itself, such as along an interior seam running along the inner thigh of the left leg. In like manner, the third fabric panel 114 may be wrapped and connected to itself, such as along an interior seam running along the inner thigh of the right leg, to define the second leg opening 132. In some embodiments, the second fabric panel 112 may include a hem at the first leg opening 130, and the third fabric panel 114 may include an additional hem at the second leg opening 132.

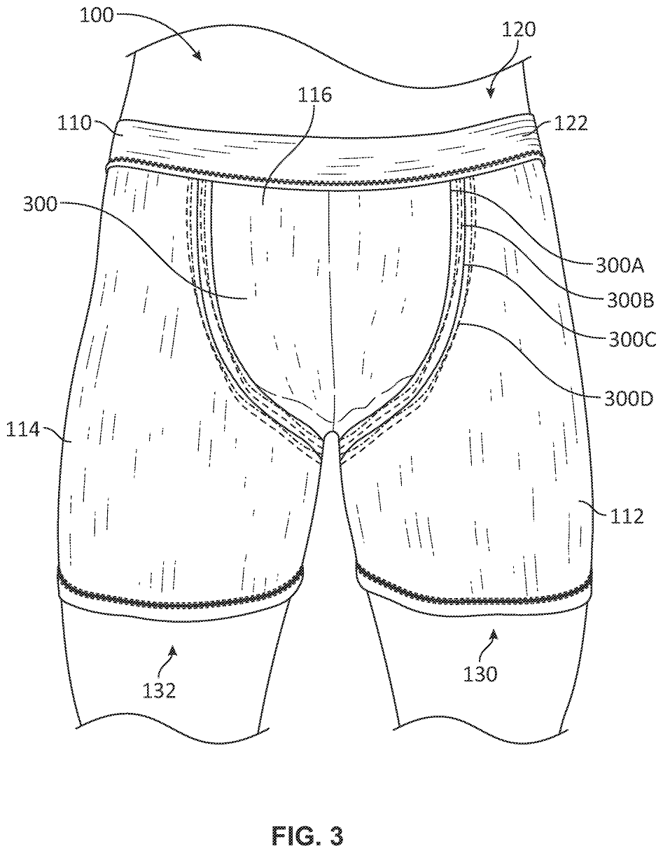

FIG. 3 illustrates a front view of the undergarment 100, in accordance with an embodiment of the disclosure. Referring to FIGS. 1 and 3, the fourth fabric panel 116 may be connected to the first fabric panel 110, the second fabric panel 112, and the third fabric panel 114 (or any combination thereof) to define a front pouch 140 of undergarment 100. For example, the fourth fabric panel 116 may be sewn, welded, or otherwise secured to the first fabric panel 110 (e.g., along the bottom of the waistband 122), the second fabric panel 112, and the third fabric panel 114. Although not illustrated, the undergarment 100 may also include a fifth fabric panel positioned below the crotch area. In such embodiments, the fifth fabric panel may be connected to the second fabric panel 112, the third fabric panel 114, and the fourth fabric panel 116 (or any combination thereof), such as between the second fabric panel 112 and the third fabric panel 114 along the crotch seam.

Referring to FIG. 3, the fourth fabric panel 116 may be selected to provide a front pouch size 300 as desired (e.g., by a buyer). For example, the fourth fabric panel 116 may be selected to best fit the undergarment 100, and in particular the front pouch size 300, to various anatomies of different buyers. Specifically, some buyers may include crotch anatomies (e.g., genitals) that are larger than average, smaller than average, or otherwise. In such examples, conventional undergarments may not provide a sufficient or comfortable fit or support, such as for the genitals of the wearer. The undergarment 100 of the present disclosure, however, may be customized to fit the particular buyer, thereby providing a better fit compared to conventional undergarments. For example, the front pouch size 300 may be increased to fit individuals with larger genitals, decreased to fit individuals with smaller genitals, or otherwise, as described more fully below.

Referring to FIG. 3, the front pouch size 300 may be selected by providing a fourth fabric panel 116 of different sizes. For instance, a larger fourth fabric panel 116 may be selected to provide a front pouch size 300 of greater size. Similarly, a smaller fourth fabric panel 116 may be selected to provide a front pouch size 300 of smaller size. As shown, the undergarment 100 may be provided with a plurality of front pouch sizes 300 for a given waist size 120. For example, the undergarment 100 may be provided with a standard front pouch size 300A, a large front pouch size 300B, an X-large front pouch size 300C, or an XX-large front pouch size 300D, among other sizes, to fit the undergarment 100 to various wearers/buyers.

In such embodiments, a buyer may select the desired size characteristics of the undergarment 100 for purchase. For instance, buyers may select a desired waist size 120 and front pouch size 300 to suit their anatomy. In some embodiments, buyers may select different characteristics of the undergarment 100 for further customization. For example, buyers may select a desired length of the undergarment 100 (e.g., leg length) and/or a desired leg opening size. In such embodiments, the second fabric panel 112 and the third fabric panel 114 may be selected to provide the leg length and/or leg opening size desired by the buyer.

Depending on the application, the undergarment 100 may include additional features. As one example, the undergarment 100 may include a storage pocket 150 (see FIG. 1). The storage pocket 150 may be positioned on the interior or the exterior of the undergarment 100 for storage of one or more items (e.g., condom(s), birth control, medicine, money, cards, ID(s), etc.). In some embodiments, the fourth fabric panel 116 may include a fly 160 (e.g., a vertical fly, a horizontal fly, etc.) that allows for convenience in urinating.

With the ability to customize the undergarment 100 to suit anatomies of different buyers, the undergarment 100 may be provided as part of an undergarment system. For example, the undergarment system may include a first undergarment (e.g., undergarment 100) and a second undergarment. The first undergarment may have a waist size and include a first front pouch having a first pouch size (e.g., standard pouch size 300A). The second undergarment may have the waist size and include a second front pouch having a second pouch size (e.g., large pouch size 300B).

To suit various anatomies, the first pouch size of the first undergarment may be different than the second pouch size of the second undergarment. Similarly, the first undergarment may include a first leg length, and the second undergarment may include a second leg length different than the first leg length. Additionally, or alternatively, the first undergarment may include a first leg opening size, and the second undergarment may include a second leg opening size different than the first leg opening size.

The undergarment system may include additional undergarments depending on desired inventory and/or sizing. For instance, the undergarment system may include a third undergarment having the waist size and including a third front pouch having a third pouch size (e.g., X-large pouch size 300C) that is different than the first pouch size and the second pouch size. In some embodiments, the undergarment system may include a fourth undergarment having the waist size and including a fourth front pouch having a fourth pouch size (e.g., XX-large pouch size 300D) that is different than the first pouch size, the second pouch size, and the third pouch size.

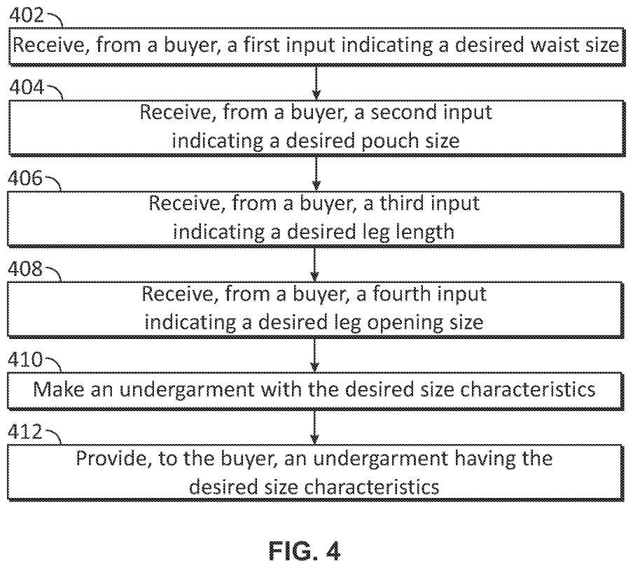

FIG. 4 illustrates a flow diagram of a method 400 of customizing an undergarment, in accordance with an embodiment of the disclosure. Any step, sub-step, sub-process, or block of method 400 may be performed in an order or arrangement different from the embodiments illustrated in FIG. 4. For example, one or more blocks may be omitted from or added to the method 400. Although method 400 is described with reference to the embodiments of FIGS. 1-3, method 400 may be applied to other embodiments.

At block 402, method 400 may include receiving, from a buyer, a first input indicating a desired waist size. For example, the buyer may input the desired waist size on a website, in an application running on a smart device (e.g., smartphone, tablet, etc.), at a store kiosk, or on an ordering form, among other methods or devices. The buyer may choose from a list of available sizes or the buyer may input an exact size desired.

At block 404, method 400 may include receiving, from the buyer, a second input indicating a desired pouch size. The buyer may input the desired pouch size on a website, in an application running on a smart device (e.g., smartphone, tablet, etc.), at a store kiosk, or on an ordering form, among other methods or devices. The buyer may choose from a list of available sizes or the buyer may input an exact size desired.

At block 406, method 400 may include receiving, from the buyer, a third input indicating a desired leg length. For example, the buyer may desire a shorter undergarment (e.g., briefs) or a longer undergarment (e.g., boxers, thermal underwear, etc.). The buyer may input the desired leg length on a website, in an application running on a smart device (e.g., smartphone, tablet, etc.), at a store kiosk, or on an ordering form, among other methods or devices. The buyer may choose from a list of available sizes or the buyer may input an exact size desired.

At block 408, method 400 may include receiving, from the buyer, a fourth input indicating a desired leg opening size. For example, the buyer may desire a narrow leg opening or a wider leg opening based on personal anatomy/fit preference. The buyer may input the desired leg opening size on a website, in an application running on a smart device (e.g., smartphone, tablet, etc.), at a store kiosk, or on an ordering form, among other methods or devices. The buyer may choose from a list of available sizes or the buyer may input an exact size desired.

At block 410, method 400 may include making an undergarment with the desired size characteristics (e.g., waist size, pouch size, leg length, leg opening size, or any combination thereof). Block 410 may include connecting a fabric panel (e.g., fourth fabric panel 116) to a main body (e.g., first fabric panel 110, second fabric panel 112, and third fabric panel 114) of the undergarment. The main body may provide the desired waist size. In addition, the main body may provide the desired leg length and/or leg opening size. The fabric panel may be selected to provide the desired pouch size, as noted above. For example, a fabric panel of a first size may be selected and connected to the main body of the undergarment to provide a pouch size of a first size (e.g., a standard pouch size). Similarly, a smaller fabric panel of a second size may be selected and connected to the main body of the undergarment to provide a pouch size of a second size (e.g., a large or larger pouch size).

At block 412, method 400 may include providing, to the buyer, an undergarment (e.g., undergarment 100) having the desired size characteristics. For example, block 412 may include providing, to the buyer, the undergarment with the desired waist size and the desired pouch size. Block 412 may include providing, to the buyer, the undergarment having the desired leg length. Block 412 may include providing, to the buyer, the undergarment having the desired leg opening size.

All relative and directional references (including up, down, upper, lower, top, bottom, side, front, rear, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

The present disclosure teaches by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. An undergarment system comprising:
a first undergarment having a waist size and comprising a first front pouch having a first pouch size; and
a second undergarment having the waist size and comprising a second front pouch having a second pouch size;
wherein the first pouch size of the first undergarment is different than the second pouch size of the second undergarment.

2. The undergarment system of claim 1, wherein:
the first undergarment comprises a first leg length; and
the second undergarment comprises a second leg length different than the first leg length.

3. The undergarment system of claim 1, wherein:
the first undergarment comprises a first leg opening size; and
the second undergarment comprises a second leg opening size different than the first leg opening size.

4. The undergarment system of claim 1, wherein at least one of the first undergarment or the second undergarment comprises:
a first fabric panel comprising an annular elastomeric waistband defining the waist size;
a second fabric panel connected to the first fabric panel and defining a first leg opening;
a third fabric panel connected to the first fabric panel and defining a second leg opening; and
a fourth fabric panel connected to the first fabric panel, the second fabric panel, and the third fabric panel and defining the first front pouch or the second front pouch.

5. The undergarment system of claim 4, wherein the at least one of the first undergarment or the second undergarment comprises a fifth fabric panel connected between the second fabric panel and the third fabric panel.

6. The undergarment system of claim 4, wherein the at least one of the first undergarment or the second undergarment comprises a storage pocket.

7. The undergarment system of claim 4, wherein the fourth fabric panel of the at least one of the first undergarment or the second undergarment comprises a fly.

8. The undergarment system of claim 1, further comprising:
a third undergarment having the waist size and comprising a third front pouch having a third pouch size different than the first pouch size and the second pouch size; and
a fourth undergarment having the waist size and comprising a fourth front pouch having a fourth pouch size different than the first pouch size, the second pouch size, and the third pouch size.

9. An undergarment comprising:
a first fabric panel comprising an annular elastomeric waistband;
a second fabric panel connected to the first fabric panel and defining a first leg opening;
a third fabric panel connected to the first fabric panel and defining a second leg opening; and
a fourth fabric panel connected to the first fabric panel, the second fabric panel, and the third fabric panel, wherein the fourth panel is selected to provide a front pouch size as desired by a buyer.

10. The undergarment of claim 10, wherein the second fabric panel and the third fabric panel are selected to provide a leg length as desired by the buyer.

11. The undergarment of claim 10, wherein the second fabric panel and the third fabric panel are selected to provide a leg opening size as desired by the buyer.

12. The undergarment of claim 10, further comprising a fifth fabric panel connected between the second fabric panel and the third fabric panel.

13. The undergarment of claim 10, further comprising a storage pocket.

14. The undergarment of claim 10, wherein the fourth fabric panel comprises a fly.

15. The undergarment of claim 10, wherein the undergarment is one of briefs, boxer briefs, or trunks.

16. A method comprising:
receiving, from a buyer, a first input indicating a desired waist size;
receiving, from the buyer, a second input indicating a desired pouch size; and
providing, to the buyer, an undergarment having the desired waist size and the desired pouch size.

17. The method of claim 15, further comprising making the undergarment with the desired waist size and the desired pouch size.

18. The method of claim 17, wherein the making the undergarment comprises connecting a fabric panel to a main body of the undergarment, the main body providing the desired waist size and the fabric panel selected to provide the desired pouch size.

19. The method of claim 15, further comprising:
receiving, from the buyer, a third input indicating a desired leg length;
wherein the providing the undergarment comprises providing, to the buyer, the undergarment having the desired leg length.

20. The method of claim 19, further comprising:
receiving, from the buyer, a fourth input indicating a desired leg opening size;
wherein the providing the undergarment comprises providing, to the buyer, the undergarment having the desired leg opening size.
